(19) United States
(12) Patent Application Publication
(10) Pub. No.: US 2009/0307871 A1
(43) Pub. Date: Dec. 17, 2009

(54) HINGE STRUCTURE HAVING A KNUCKLE WITH ANTI-UNFOLDING PROPERTY

(75) Inventor: LIN-KAI HUNG, Taipei County (TW)

Correspondence Address: ROSENBERG, KLEIN & LEE, 3458 ELLICOTT CENTER DRIVE-SUITE 101, ELLICOTT CITY, MD, 21043, US

(73) Assignee: PROTORSION HINGE CO., LTD., TAIPEI COUNTY (TW)

(21) Appl. No.: 12/168,378

(22) Filed: Jul. 7, 2008

(30) Foreign Application Priority Data
Jun. 11, 2008 (TW) 097210308

(51) Int. Cl. E05D 7/00

(52) U.S. Cl. 16/226

(57) ABSTRACT

A hinge structure includes a shaft extending into a knuckle. The knuckle, when stretched-out, includes a knuckle body having a right portion and a left portion for coupling with the right portion. The knuckle body has a protrusion member projecting outwardly from the right portion with a neck section proximate to the right portion and a head section. The head section has a width greater than a width of the neck section. The knuckle body further has a recess member extending inwardly from the left portion with a narrow section proximate to the left portion and a large section. The large section has a width greater than a width of the narrow section. The width of the head section is greater than the width of the narrow section while the width of the neck section is smaller than the width of the narrow section in order to extend therethrough.

### FIELD OF THE INVENTION

The present invention relates to a hinge structure, and more particularly to a hinge structure including a knuckle, when unfolded and in a stretched-out state, has a knuckle body consisting of a right end portion a left portion formed with protrusion and recess for coupling each other, thereby providing anti-unfolding property to the knuckle of the hinge structure.

### BACKGROUND OF THE INVENTION

In our daily life, a hinge structure is implemented when two objects are required to be folded or unfolded relative to each other. Referring to FIG. 1, a conventional hinge structure is shown to include a male member 1 and a female member 2. The male member 1 generally includes a pivot shaft 11 and a coupling portion 12 extending from the pivot shaft 11 while the female member 2 includes a knuckle 21 and a coupling portion 22 extending from the knuckle 21. Under the normal condition, the pivot shaft 11 extends rotatably into the knuckle 21 while one object (not shown) is mounted on the coupling portion 12. Another object (not shown) is mounted on the coupling portion 22 of female member 2 such that the two objects can be folded onto or unfolded away from each other about an axis of the pivot shaft 11.

FIG. 2 is an unfolded and stretched-out view of the female member 2, wherein the knuckle 21 is made from a flat metal plate, and includes a knuckle body having two opposite constricted ends 211, each with a width smaller than its central portion in order to facilitate flexible deformation thereof. Under this condition, the knuckle 21 is formed once the knuckle body is rolled along a circular path so as to juxtapose the constricted ends 211, thereby receiving the pivot shaft 11 rotatably therein.

After assembly, since a slit 212 is formed between the constricted ends 211 of the knuckle body, frequent rotation of the pivot shaft 11 within the knuckle 21 results in loosening and lowering of the torque therebetween, finally rendering the two objects using the conventional hinge structure unable to fold relative to each other.

### SUMMARY OF THE INVENTION

The present invention is to provide a hinge structure that includes a knuckle having a knuckle body consisting of a protrusion member projecting outwardly from a right end portion and a recess member extending inwardly from a left end portion and capable of coupling with the protrusion member in order to form the knuckle, thereby providing anti-unfolding property.

In accordance with the present invention, a hinge structure is provided to include a pivot shaft and a knuckle receiving the pivot shat rotatably therein. The knuckle, when unfolded and in a stretched-out state, includes a knuckle body having a right end portion and a left portion opposite to and capable of coupling with the right end portion in order to form the knuckle. The knuckle body further has a protrusion member projecting outwardly from the right end portion with a neck section proximate to the right end portion and a head section distal to the right end portion. The head section has a width greater than a width of the neck section. The knuckle body further has a recess member extending inwardly from the left end portion with a narrow section proximate to the left end portion and a large section distal to the left end portion. The large section has a width greater than a width of the narrow section. The width of the head section is greater than the width of the narrow section while the width of the neck section is smaller than the width of the narrow section in order to extend therethrough.

The knuckle, when unfolded and in the stretched-out state, includes a knuckle body having protrusion and recess members at two opposite end portions in such a manner that the protrusion member is adapted to engage the recess member so that frequent rotation of the pivot shaft within the knuckle does not result in disengagement therebetween. In other words, the hinge structure of the present invention is adapted to receive a relatively large load due to possession of anti-unfolding property.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is an exploded and perspective view of a conventional hinge structure;

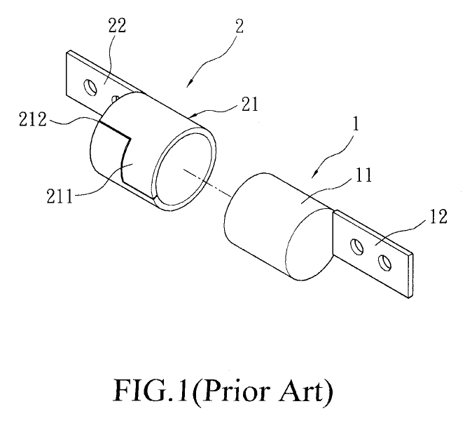

FIG. 2 illustrates an unfolded and stretched-out view of a knuckle employed in the conventional hinge structure;

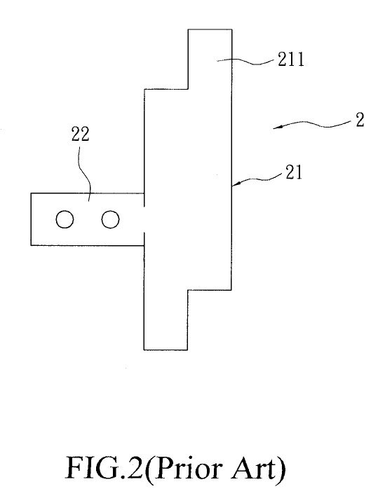

FIG. 3 is an exploded and perspective view of the first embodiment of a hinge structure of the present invention;

FIG. 4 illustrates an unfolded and stretched-out view of a knuckle employed in the first embodiment of the hinge structure of the present invention;

FIG. 5 is an exploded and perspective view of the second embodiment of the hinge structure of the present invention; and

FIG. 6 illustrates an unfolded and stretched-out view of a knuckle employed in the second embodiment of the hinge structure of the present invention.

### DETAILED DESCRIPTIONS OF THE PREFERRED EMBODIMENTS

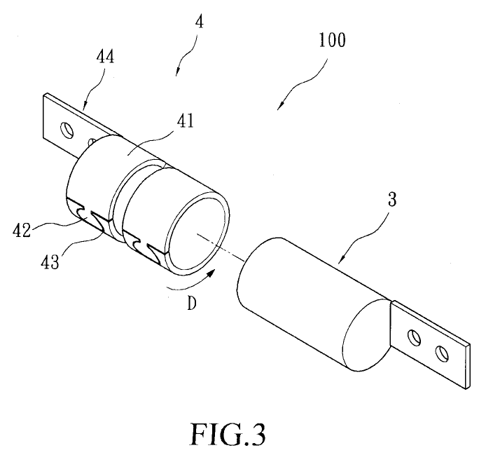

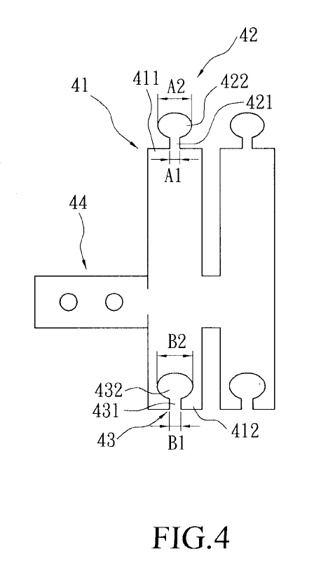

FIG. 3 shows an exploded and perspective view of the first embodiment of a hinge structure of the present invention. FIG. 4 illustrates an unfolded and stretched-out view of a knuckle employed in the first embodiment of the hinge structure of the present invention. As illustrated, the hinge structure 100 includes a pivot shaft 3 and a knuckle 4 receiving the pivot shat 3 rotatably therein. During rotation of the pivot shaft within the knuckle 4, a torque is generated so that the pivot shaft 3 requires a force to overcome the torque.

The knuckle 4 is preferably made from a flat metal plate. When unfolded and in a stretched-out state, the knuckle 4 includes a knuckle body 41 and a coupling portion 44 extending outwardly from the knuckle body 41 in order to fasten a first object (not shown) thereon. The knuckle body 41 has a right end portion 411 and a left portion 412 opposite to and capable of coupling with the right end portion 411 along a circular path D in order to form the knuckle 4. In this embodiment, there are two knuckle bodies 41 or more than two knuckle bodies 41. Each knuckle body 41 further has a protrusion member 42 projecting outwardly from the right end portion 411 and a recess member 43 extending inwardly from the left end portion 412.

When unfolded and in the stretched-out state, the protrusion member 42 projects outwardly from the right end portion 411 along a longitudinal length of the knuckle body 41. Alternately, when unfolded and in the stretched-out state, a portion of the protrusion member 42 is bent such that the bent portion projects outwardly from the right end portion 411 opposite to the longitudinal length of the knuckle body 41. The protrusion member 42 consists of a neck section 421 proximate to the right end portion 411 and a head section 422 distal to the right end portion 411. The head section 422 has a width A2 greater than a width A1 of the neck section 421.

When unfolded and in the stretched-out state, the recess member 43 extends inwardly from the left end portion 412 along a longitudinal length of the knuckle body 41. Alternately, when unfolded and in the stretched-out state, a portion of the recess member 43 is bent such that the bent portion extends from the left end portion 412 opposite to the longitudinal length of the knuckle body 41. The recess member 43 consists of a narrow section 431 proximate to the left end portion 412 and a large section 432 distal to the left end portion 412. The large section 432 has a width B2 greater than a width B1 of the narrow section 431. In this embodiment, the head section 422 of the right end portion 42 generally has a circular shape. The large section 432 of the left end portion 43 also generally has a circular shape in order to complement with the head section 422. The head section 422 and the neck section 421 of the right end portion 42 may generally have a T shape (not shown). Similarly, the large section 432 and the narrow section 431 of the left end portion 43 may generally have a T shape in order to complement with the head section 422. In the same manner, the head section 422 of the right end portion 42 generally has a triangular shape (not shown). The large section 432 of the left end portion 43 generally has a triangular shape to complement with the head section 422.

In order to facilitate coupling the protrusion member 42 with the recess member 43 due to rolling of the knuckle body 41 along the circular direction D (see FIG. 3), the width A2 of the head section 422 should be greater than the width B1 of the narrow section 431 while the width A1 of the neck section 421 is smaller than the width B1 of the narrow section 431, thereby permitting the neck section 421 through the narrow section 431 once the protrusion member 42 is engaged within the recess member 43.

Thus after assembly of the knuckle 4 and when the pivot shaft 3 is rotated within the knuckle 4 several times, the protrusion member 42 and the recess member 43 are disposed under tension due to relative engagement therebetween. In other words, the protrusion member 42 and the recess member 43 are prevented from disengaging each other (possessing anti-unfolding property), thereby eliminating the drawback encountered during use of the prior art hinge structure.

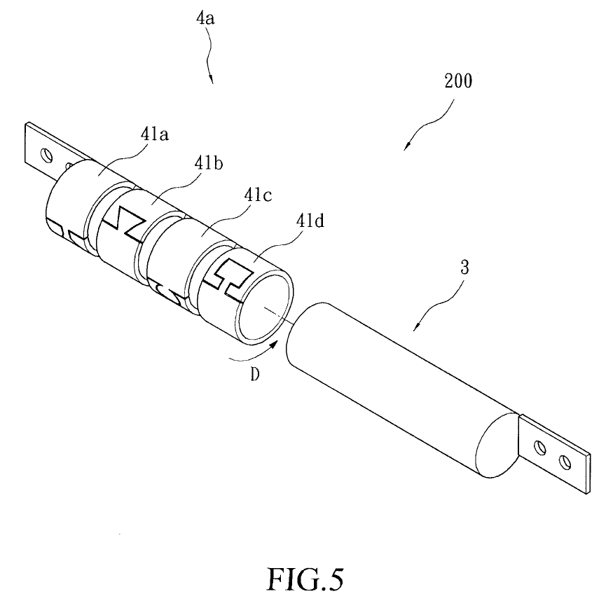

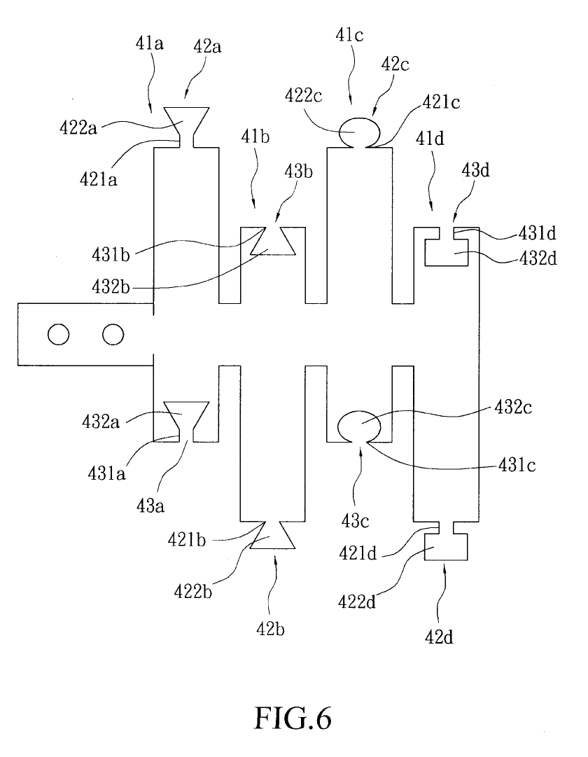

FIG. 5 is an exploded and perspective view of the second embodiment of the hinge structure 200 of the present invention. FIG. 6 illustrates an unfolded and stretched-out view of a knuckle employed in the second embodiment of the hinge structure 200 of the present invention. As illustrated, the second embodiment is differed from the first embodiment in the structure of the knuckle 4a. The knuckle 4a, when in the stretched-out state, includes first, second third and fourth knuckle bodies 41a, 41b, 41c, and 41d. Each of the knuckle bodies 41a, 41b, 41c, 41d has a protrusion member 42a, 42b, 42c, 42d at one end portion thereof, and a recess member 43a, 43b, 43c, 43d at the other end portion thereof and complementing with the protrusion member 42a, 42b, 42c, 42d such that rolling action of the knuckle bodies 41a, 41b, 41c, 41d along the circular path D results in engagement of the protrusion members 42a, 42b, 42c, 42d within the recess member 43a, 43b, 43c, 43d respectively.

During the rolling action for forming the knuckle 4, the knuckle bodies 41a, 41c is rolled along the circular path D in a first direction in order to engage the protrusion members 42a, 42c respectively within the recess members 43a,43c. Simultaneously, the knuckle bodies 41b, 41d are rolled along the circular path D in a second direction opposite to the first direction in order to engage the protrusion members 42b, 42d respectively within the recess members 43b, 43d.

In the second embodiment, each of the knuckle bodies 41a, 41b, 41c, 41d has short and long end portions, where the protrusion and recess members 42a-42d, 43a-43d are formed respectively. Note that in order to bear a larger load and bidirectional torque, the short and long end portions of one knuckle body 41 are respectively staggered with the short and long end portion of the succeeding knuckle body 41b such that two pairs of the knuckle bodies are rolled in the aforesaid manner to engage the protrusion members 42a-42d respectively in the recess member 43a-43d.

The head section 422a at the long end portion of the first knuckle body 41a generally has a triangular shape. The head section 422b at the short end portion of the second knuckle body 41b generally has a triangular shape. Of course, the large sections 432a, 432b of the recess members 43a, 43b at the first and second knuckle bodies 41, and 41b have triangular shapes in order to complement with and engage the head sections 422a, 422b respectively. The head section 422c at the long end portion of the third knuckle body 41c generally has a circular shape. The large sections 432c of the recess member 43c at the short end portion of the third knuckle body 41c has a circular shape to receive the head section 422c. Similarly, the head section 422d and the neck section 421d constituting the protrusion member 42d at the long end portion of the fourth knuckle body 42d generally has a T shape while the large section 432d and the narrow section 431d constituting the recess member 43d at the short end portion of the fourth knuckle body 42d generally has a T shape in order to complement with and engage the head section 422d.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements. The hinge structure of the present invention is widely used in variety of structures when two objects are required to be folded relative to each other.

What is claimed is:

1. A hinge structure with anti-unfolding property, comprising:
a pivot shaft;
a knuckle receiving said pivot shat rotatably therein, said knuckle, when unfolded and in a stretched-out state, including a knuckle body having a right end portion and a left portion opposite to and capable of coupling with said right end portion in order to form said knuckle;
said knuckle body further having a protrusion member projecting outwardly from said right end portion with a neck section proximate to said right end portion and a head section distal to said right end portion, said head section having a width greater than a width of said neck section, said knuckle body further having a recess member extending inwardly from said left end portion with a narrow section proximate to said left end portion and a large section distal to said left end portion, said large section having a width greater than a width of said narrow section; and
wherein, said width of said head section is greater than said width of said narrow section while said width of said neck section is smaller than said width of said narrow section in order to extend therethrough.

2. The hinge structure according to claim 1, wherein when unfolded and in said stretched-out state, said knuckle body is rolled along a circular path in order to couple said right and left end portions, thereby receiving said pivot shat rotatably therein.

3. The hinge structure according to claim 1, wherein when unfolded and in said stretched-out state, said protrusion member projects outwardly from said right end portion along a longitudinal length of said knuckle body.

4. The hinge structure according to claim 1, wherein when unfolded and in said stretched-out state, said recess member extending inwardly from said left end portion along a longitudinal length of said knuckle body.

5. The hinge structure according to claim 3, wherein when unfolded and in said stretched-out state, a portion of said protrusion member is bent such that said bent portion projects outwardly from said right end portion opposite to said longitudinal length of said knuckle body.

6. The hinge structure according to claim 4, wherein when unfolded and in said stretched-out state, a portion of said recess member is bent such that said bent portion extends from said left end portion opposite to said longitudinal length of said knuckle body.

7. The hinge structure according to claim 1, wherein said head section of said right end portion generally has a circular shape.

8. The hinge structure according to claim 1, wherein said head section and said neck section of said right end portion generally has a T shape.

9. The hinge structure according to claim 1, wherein said head section of said right end portion generally has a triangular shape.

10. The hinge structure according to claim 1, wherein said large section of said left end portion generally has a circular shape.

11. The hinge structure according to claim 1, wherein said large section and said narrow section of said left end portion generally has a T shape.

12. The hinge structure according to claim 1, wherein said large section of said left end portion generally has a triangular shape.
